(19) United States
(12) Patent Application Publication
(10) Pub. No.: US 2007/0008375 A1
(43) Pub. Date: Jan. 11, 2007

(54) Head module, liquid ejection head, liquid ejection apparatus, and method of fabricating head module

(76) Inventors: Toru Tanikawa, Kanagawa (JP); Makoto Ando, Tokyo (JP); Yoshiyuki Matsuo, Aichi (JP)

Correspondence Address: ROBERT J. DEPKE;LEWIS T. STEADMAN, ROCKEY, DEPKE, LYONS AND KITZINGER, LLC, SUITE 5450 SEARS TOWER, CHICAGO, IL, 60606-6306, US

(21) Appl. No.: 11/473,585

(22) Filed: Jun. 23, 2006

(30) Foreign Application Priority Data
Jun. 24, 2005 (JP) 2005-185282
Jun. 24, 2005 (JP) 2005-185284

(51) Int. Cl. B41J 2/14; B41J 2/16

(52) U.S. Cl. 347/50

(57) ABSTRACT

A head module includes a nozzle sheet, a wiring board, and a module frame having a plurality of head-chip positioning holes formed therein, and a head chip including an electrode. The head chip is disposed in each head-chip positioning hole. The nozzle sheet is disposed on a first surface of the module frame so as to partially cover the head-chip positioning hole. The size of the nozzle sheet is set to a minimum size required for partially covering the head-chip positioning hole. The head chip is disposed from a second surface of the module frame. The electrode is exposed through an area of the head-chip positioning hole not covered by the nozzle sheet. An electrode of the wiring board is electrically connected to the electrode of the head chip and the wiring board is disposed on the first surface of the module frame so as to cover the exposed electrode.

### CROSS REFERENCES TO RELATED APPLICATIONS

The present invention contains subject matter related to Japanese Patent Application JP 2005-185282 filed in the Japanese Patent Office on Jun. 24, 2005, and Japanese Patent Application JP 2005-185284 filed in the Japanese Patent Office on Jun. 24, 2005, the entire contents of which are incorporated herein by reference.

### BACKGROUND OF THE INVENTION

1. Field of the Invention

The present invention relates to a head module included in a head for ejecting liquid, a liquid ejection head using the head module, a liquid ejection apparatus using the head module, and a method of fabricating the head module. More particularly, the present invention relates to a technology for reducing the cost of materials of a head module and a technology for smoothing a nozzle surface of the head module.

2. Description of the Related Art

Inkjet printers have been well known as examples of a liquid ejection apparatus. A variety of technologies relating to a head (a liquid ejection head) included in the inkjet printers have been proposed.

For example, Japanese Patent No. 3608526 describes a technology in which a plurality of head chips are bonded to a nozzle sheet so as to form a line head.

In this technology described in Japanese Patent No. 3608526, a plurality of nozzles (ink ejection ports) are formed in a nickel nozzle sheet produced by means of electroforming. Thereafter, a plurality of head chips are bonded to the nozzle sheet. Furthermore, a head frame having holes is bonded to the nozzle sheet so that the bonded head chip is surrounded by the holes, and the nozzle sheet is supported by the head frame.

Additionally, Japanese Unexamined Patent Application Publication No. 2005-131948 describes a technology in which one liquid ejection head is divided into a plurality of head modules. After the head modules are fabricated, the fabricated head modules are lined up to form a liquid ejection head.

In the technology described in Japanese Unexamined Patent Application Publication No. 2005-131948, a nozzle sheet is bonded to each head module, to which four head chips are attached.

The technology described in Japanese Patent No. 3608526 can increase the precision with which the position of each nozzle is provided, since one nozzle sheet forms one liquid ejection head. However, this technology has a disadvantage in that an increase in the size of the nozzle sheet reduces the strength of the nozzle sheet, and therefore, the nozzle sheet is easily deformed and damaged. In addition, if a part of the nozzle sheet is damaged or part of the liquid ejection head is damaged due to a shift of the mounted position of the head chip, the entire liquid ejection head becomes defective. Thus, the manufacturing step management is difficult, and therefore, mass production is difficult. Furthermore, from a viewpoint of maintainability, even when the damage or malfunction of the head chip is partial, the entire liquid ejection head should be replaced. This is inefficient and entails a high repair cost.

In contrast, in the technology described in Japanese Unexamined Patent Application Publication No. 2005-131948, since the liquid ejection head is divided into a plurality of head modules, only a defective or malfunction head module can be replaced with a new one. Thus, this liquid ejection head is suitable for mass production. In addition, this liquid ejection head advantageously has good maintainability.

The nozzle sheet is a thin film formed from a metal, such as nickel. The nozzle sheet is finely processed by means of, for example, electroforming. Accordingly, the technology described in Japanese Unexamined Patent Application Publication No. 2005-131948 requires less manufacturing cost than the technology described in Japanese Patent No. 3608526. However, since one nozzle sheet is bonded to the module frame, the cost of the nozzle sheet is still high.

Additionally, as described in the above-described Japanese Patent No. 3608526, Japanese Unexamined Patent Application Publication No. 2003-175609, and Japanese Unexamined Patent Application Publication No. 2004-223878, a rigid head frame of a head (liquid ejection head) used for inkjet printers supports a nozzle sheet in which a plurality of nozzles for ejecting ink are arranged. In addition, on the nozzle sheet, a head chip having a barrier layer for forming a liquid chamber and an energy-generating element (e.g., a heater element) are mounted. A wiring board is connected to the head chip. In response to a command from a controller of a printer, the head chip drives the energy-generating element to provide an ejecting force to ink in the liquid chamber. Thus, the ink is ejected from the nozzles so that an image is printed.

In this head, an electrode adjacent to the head chip is connected to a terminal adjacent to the wiring board using a gold wire (bonding wire). The interconnection is carried out through a window formed in the nozzle sheet by means of a bonding apparatus. The window is provided for carrying out the electrical interconnection. The window is disposed so as to allow the gold wire to pass therethrough from the front surface of the nozzle sheet to the wiring board disposed on the back surface of the nozzle sheet. If the window is always open, a large amount of ink or dust may enter the head, and therefore, a short circuit may occur or contamination may occur in the head. Therefore, after the interconnection is completed, the window is closed to prevent foreign particles from contaminating the interior of the head. The window is sealed with a resin sealer such that the resin sealer surrounds the gold wire exposed through the window. When the window is closed with the resin sealer, the gold wire and its connection part are fixed with the resin sealer. Accordingly, the head is protected from contamination by foreign particles. In addition, the gold wire is protected from coming off due to vibrations or shocks.

However, in the method in which the window is formed to carry out an electrical interconnection and is sealed after wire bonding is completed, the number of manufacturing steps increases, and therefore, the manufacturing cost increases. As another problem, the resin sealer nonuniformly protrudes from the surface of the nozzle sheet on the ink ejecting side (nozzle surface). This protruding resin sealer interferes with cleaning of the nozzle surface.

Thus, the above-described head requires the resin sealing step for securing and protecting the interconnected gold wire in addition to the wire bonding step, and therefore, the number of the manufacturing steps is increased. Accordingly, the manufacturing cost disadvantageously increases. Furthermore, inkjet printers that carry out cleaning of the nozzle surface to maintain the ejection performance are widely used. In the cleaning operation, a cleaning member, such as a roller or a blade, slides on the nozzle surface to remove contamination deposited on the nozzle surface. It is desirable that the nozzle surface is flat so that the contact pressure of the cleaning member against the nozzle surface is uniform. However, in the above-described head, since the resin sealer is regionally lifted up from the nozzle surface, the cleaning performance is degraded.

### SUMMARY OF THE INVENTION

Accordingly, the present invention provides a head module, a liquid ejection head, a liquid ejection apparatus, and a method of fabricating the head module for reducing the cost of materials of the head module, reducing the deformation and damage of a nozzle sheet, and smoothing a nozzle surface of the head module.

According to an embodiment of the present invention, a head module includes a head chip, a nozzle sheet, a wiring board, and a module frame. The head chip includes a plurality of energy-generating elements, a barrier layer, and an electrode for external electrical connection provided on a semiconductor substrate. The energy-generating elements are arranged substantially in a line with a predetermined spacing therebetween. The barrier layer forms a liquid chamber around the energy-generating elements. The nozzle sheet has nozzles formed therein. The wiring board is electrically connected to the electrode of the head chip. The module frame has a plurality of head chip positioning holes formed therein. The size of each head chip positioning hole is slightly larger than the head chip and the head chip is disposed in one of the head chip positioning holes. Liquid in the liquid chamber is ejected from the nozzles by means of an ejecting force provided to the liquid by the energy-generating elements. The nozzle sheet is disposed on a first surface of the module frame so that the nozzles are located in the head chip positioning hole and the nozzle sheet partially covers the head chip positioning hole and the size of the nozzle sheet is determined to be a minimum size required for partially covering the head chip positioning hole. The head chip is disposed on a second surface of the module frame so that the head chip is located in the head chip positioning hole and the energy-generating elements face their corresponding nozzles. The electrode of the head chip disposed in the head chip positioning hole is exposed through an area of the head chip positioning hole not covered by the nozzle sheet. An electrode of the wiring board is electrically connected to the electrode of the head chip and the wiring board is disposed on the first surface of the module frame so as to cover the exposed electrode of the head chip.

According to another embodiment of the present invention, a method of manufacturing a head module includes the following steps. The head module includes a head chip including a plurality of energy-generating elements, a barrier layer, and an electrode for external electrical connection on a semiconductor substrate. The energy-generating elements are arranged substantially in a line with a predetermined spacing therebetween. The barrier layer forms a liquid chamber around the energy-generating elements. A nozzle sheet has nozzles formed therein. A wiring board is electrically connected to the electrode of the head chip. A module frame has a plurality of head chip positioning holes formed therein. The head chip is disposed in one of the head chip positioning holes. Liquid in the liquid chamber is ejected from the nozzles by means of an ejecting force provided to the liquid by the energy-generating elements. The method includes the steps of (a) bonding, in a first temperature environment, the nozzle sheet to a first surface of the module frame so that the nozzles are located in the head chip positioning hole and the nozzle sheet partially covers the head chip positioning hole, (b) bonding, in a second temperature environment in which a temperature is lower than a temperature in the first environment, the head chip to a second surface of the module frame so that the head chip is located in the head chip positioning hole and the energy-generating elements face their corresponding nozzles, (c) mounting the wiring board on the first surface of the module frame so that an electrode of the wiring board is electrically connected to the electrode of the head chip, and (d) coating ends of the nozzle sheet and the wiring board bonded to the module frame.

### BRIEF DESCRIPTION OF THE DRAWINGS

FIG. 1 is a plan view of a liquid ejection head according to an embodiment of the present invention, viewed from a liquid ejection surface of the liquid ejection head;

FIG. 2 is a plan view of the liquid ejection head viewed from a surface opposite the liquid ejection surface;

FIG. 3 is a diagram illustrating the liquid ejection head shown in FIG. 2 at the front of which a control board is disposed;

FIG. 4 is a cross-sectional view of one of head chips and the vicinity of the head chip;

FIGS. 5A-C are plan views illustrating the manufacturing steps of a module frame;

FIG. 6 is a plan view of the head module after a nozzle sheet and the head chip are bonded to the module frame and a flexible wiring board is bonded to the head modules;

FIG. 7 is a perspective view illustrating the head chip, the nozzle sheet, and the flexible wiring board;

FIG. 8 is a plan view illustrating the flexible wiring board and a buffer tank;

FIG. 9 is a cross-sectional view of a head chip and the vicinity of the head chip manufactured using a method according to an embodiment of the present invention;

FIG. 10 is a plan view of the module frame, the nozzle sheet, and the flexible wiring board on which a protective cover is bonded;

FIG. 11 is a cross-sectional view of a head chip and the vicinity thereof in a liquid ejection head manufactured using a method according to an embodiment of the present invention; and

FIG. 12 is a plan view of a module frame, a nozzle sheet, and a flexible wiring board on which a protective cover is formed.

### DESCRIPTION OF THE PREFERRED EMBODIMENTS

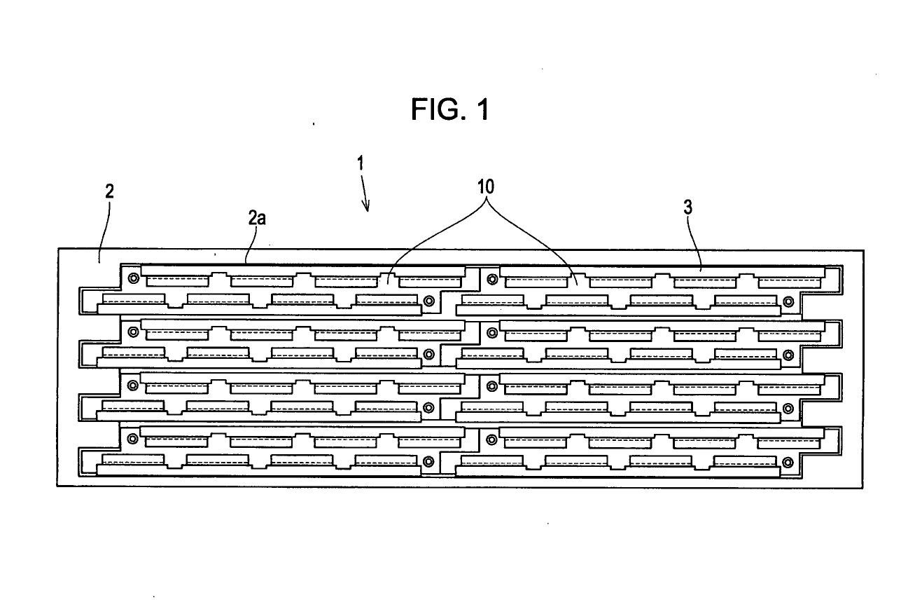

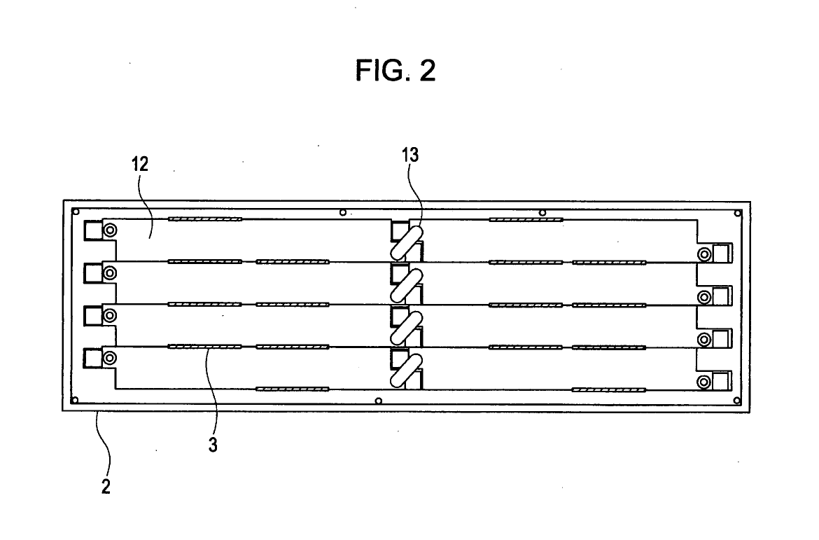

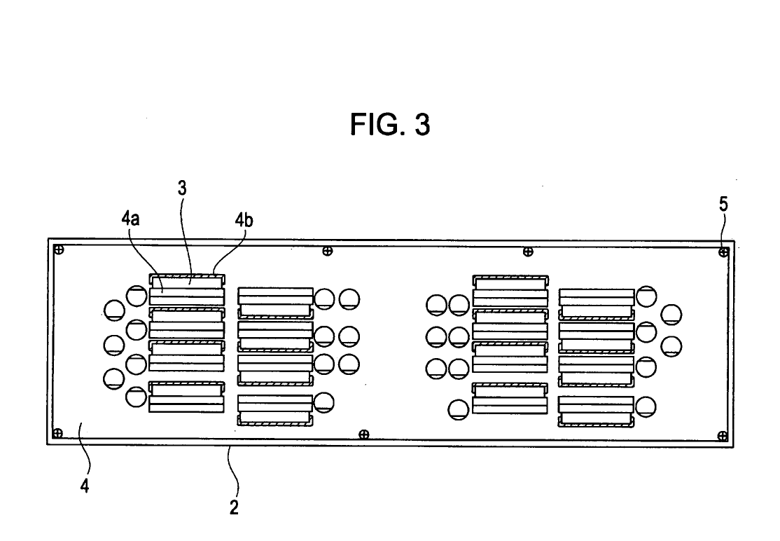

Exemplary embodiments of the present invention are described with reference to the accompanying drawings. FIG. 1 is a plan view of a liquid ejection head 1 according to an embodiment of the present invention, viewed from the liquid ejection surface. FIG. 2 is a plan view of the liquid ejection head 1 viewed from a surface opposite the liquid ejection surface. FIG. 3 is a diagram illustrating the liquid ejection head 1 shown in FIG. 2 at the front of which a control board 4 is disposed.

The liquid ejection head 1 is used as a head mounted in a liquid ejection apparatus (a color line inkjet printer in this embodiment). As shown in FIG. 1, the liquid ejection head 1 includes a head frame 2, a flexible wiring board 3, and a plurality of head modules 10. As shown in a plan view of FIG. 1, in a head module positioning hole 2a, two head modules 10 are connected in series in the length direction. The two head modules 10 cover the width of an A4 size paper so as to print an image for one color. Four lines, each including the two head modules 10 connected in series, are arranged so as to form the liquid ejection head 1 for four colors (Y, M, C, and K).

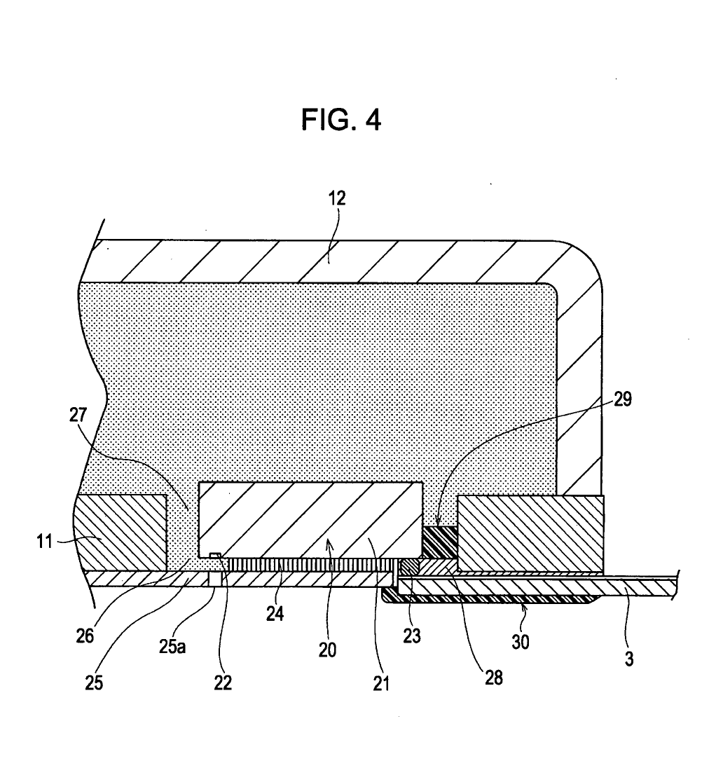

Each of the head modules 10 includes eight head chips 20. FIG. 4 is a cross-sectional view of the one of the head chips 20 and the vicinity of the head chip.

Each of the head chips 20 includes a semiconductor substrate 21 made of, for example, silicon and a heater element 22 formed on a surface of the semiconductor substrate 21 by deposition. The heater element 22 corresponds to the energy-generating element according to this embodiment of the present invention. The heater element 22 is formed at an edge of the surface of the semiconductor substrate 21. At an edge opposite that edge, an electrode 23 is formed on the surface of the semiconductor substrate 21.

The heater element 22 is connected to the electrode 23 via a conductive portion (not shown) formed on the semiconductor substrate 21.

On the surface of the head chip 20 on which the heater element 22 is formed, a barrier layer 24 and a nozzle sheet 25 are stacked. The barrier layer 24 forms the side wall of an ink liquid chamber (pressurizing chamber) 26. The barrier layer 24 also brings the head chip 20, which will be described below, into contact with the nozzle sheet 25. The barrier layer 24 is formed from, for example, a photosensitive cyclized rubber resist or an exposure-cured dried film resist. After the photosensitive cyclized rubber resist or the exposure-cured dried film resist is layered on the entire surface of the semiconductor substrate 21 of the head chip 20 on which the heater element 22 is formed, unnecessary part is removed by means of a photolithography process so that the barrier layer 24 is formed. In addition, the barrier layer 24 has a substantially block-letter U shape in plan view which surrounds three of the four sides of the heater element 22.

Furthermore, a plurality of nozzles 25a are formed in the nozzle sheet 25. For example, the nozzles 25a are formed from nickel by means of electroforming. The nozzle sheet 25 is bonded to the barrier layer 24 so that the position of the nozzle 25a is aligned with the position of the heater element 22, that is, the nozzle 25a faces the heater element 22 and, more specifically, the center axis of the nozzle 25a coincides with the center axis of the heater element 22 in plan view.

The semiconductor substrate 21, the barrier layer 24, and the nozzle sheet 25 form an ink chamber 26 so as to surround the heater element 22. The ink chamber 26 is filled with ink to be ejected. When the ink is ejected, the ink chamber 26 serves as a pressurizing chamber of the ink. The surface of the semiconductor substrate 21 on which the heater element 22 is formed functions as the bottom wall of the ink chamber 26, while the U-shaped portion of the barrier layer 24 that surround the heater element 22 functions as the side wall of the ink chamber 26. Additionally, the nozzle sheet 25 functions as the top wall of the ink chamber 26. As shown in FIG. 4, the ink chamber 26 communicates with a flow path 27 formed between the head chip 20 and a module frame 11.

In general, each of the head chips 20 includes sets of 100 heater elements 22. In response to an instruction from a control unit of a printer (not shown), one of the heater element 22 can be selected, and ink in the ink chamber 26 corresponding to the selected heater element 22 can be ejected from the nozzle 25a facing the ink chamber 26.

That is, when the ink chamber 26 is filled with ink, a pulse current, for example, is applied to the heater element 22 for a short period of time (e.g., 1 to 3 seconds). Thus, the heater element 22 rapidly generates heat. Consequently, the ink in contact with the heater element 22 generates a bubble. The expansion of the bubble expels a certain volume of the ink (the ink is boiled). Ink having the same volume as the expelled volume is ejected from the nozzle 25a in the form of an ink droplet. Accordingly, by depositing the ink droplets on a recording paper sheet, a dot (pixel) can be created.

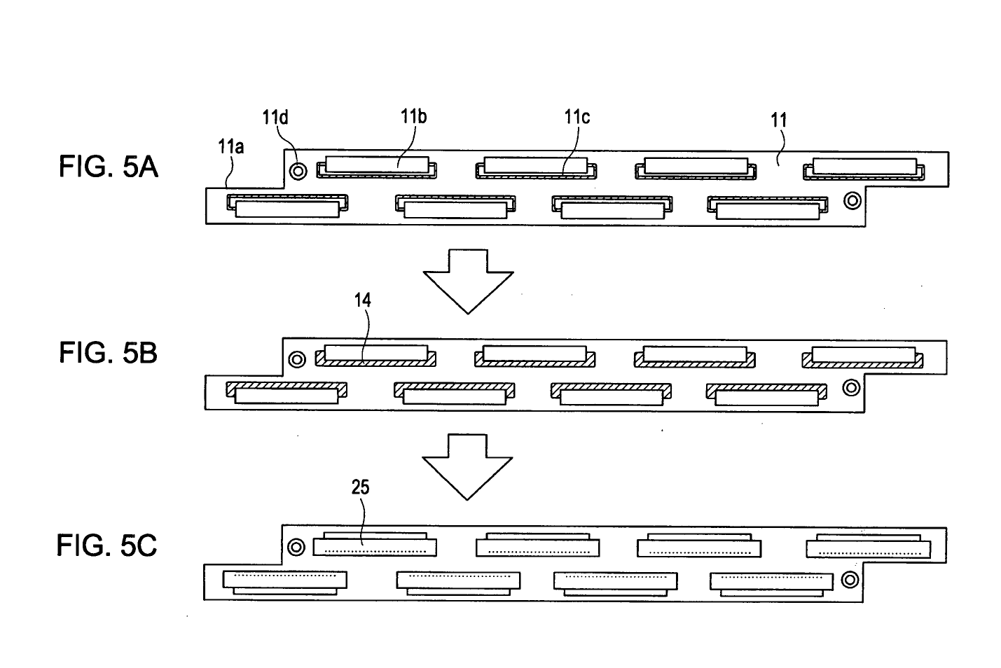

The more detailed structure and the manufacturing steps of the head module 10 are described next. FIG. 5A is a plan view of the module frame 11. According to the present embodiment, the head module 10 includes the module frame 11, eight of the head chips 20, the nozzle sheet 25, and a buffer tank 12.

The module frame 11 is substantially rectangular in plan view. The module frame 11 has fitting portions 11a on the left and right sides. The fitting portions 11a are cutout portions having a substantially L shape.

The module frame 11 is formed from, for example, a stainless steel having a thickness of about 0.5 mm. In this embodiment, eight head-chip positioning holes 11b having a substantially rectangular shape are formed in the module frame 11. Each of the head-chip positioning holes 11b is slightly larger than the exterior of the head chip 20 so that the head chip 20 can be disposed inside the head-chip positioning holes 11b.

Additionally, two mounting holes 11d are formed in the module frame 11. The mounting holes 11d are used for fixing the head module 10 to the head frame 2. Furthermore, in the module frame 11, a groove 11c (shown by cross-hatchings in FIG. 5A) is formed so as to surround part of the outer edge of each of the head-chip positioning holes 11b.

FIGS. 5A-C illustrate manufacturing steps in which the nozzle sheet 25 is bonded to the module frame 11. As shown in FIG. 5B, an adhesive agent 14 is applied to (printed on) a region surrounded by the edge of the head-chip positioning hole 11b and the groove 11c. The region for the adhesive agent 14 is substantially the same as the outer edge of the nozzle sheet 25 in size when the nozzle sheet 25 is bonded to the module frame 11.

After the adhesive agent 14 is applied, the nozzle sheet 25 is bonded to the module frame 11 (see FIG. 5C). At that time, some of the adhesive agent 14 enters the interior of the groove 11c so as to be absorbed by the groove 11c.

Additionally, the nozzle sheet 25 is bonded to the module frame 11 so as to partially cover the head-chip positioning hole 11b. Furthermore, the size of the nozzle sheet 25 is determined to be the minimum size of the nozzle sheet 25 required to be supported by the module frame 11. Accordingly, when the nozzle sheet 25 is bonded to the module frame 11, the nozzle sheet 25 covers only a part of the head-chip positioning hole 11b and the region applied with the adhesive agent 14. That is, the nozzle sheet 25 has a minimal size so as to cover the required partial area of the head-chip positioning hole 11b and so as to have a minimal adhesive area.

Furthermore, in the present embodiment, the nozzle sheet 25 is bonded by means of heat bonding using a hot press. This bonding operation is performed at the maximum temperature among those used for manufacturing the head modules 10 and the liquid ejection head 1 (e.g., about 150° C.: a first temperature environment according to the embodiment of the present invention). When the module frame 11 is compared with the nozzle sheet 25, the nozzle sheet 25 has a coefficient of linear expansion higher than that of the module frame 11 (i.e., the nozzle sheet 25 more easily expands and contracts in accordance with changes in temperature). Accordingly, by bonding nozzle sheet 25 to the module frame 11 at the maximum temperature of those used in the manufacturing steps, the nozzle sheet 25 is expanded by the module frame 11 at a temperature lower than the maximum temperature (e.g., a room temperature).

That is, after the nozzle sheet 25 is bonded to the module frame 11, the expansion and contraction of the nozzle sheet 25 caused by changes in temperature are controlled by the module frame 11.

Accordingly, to ensure the rigidity of the module frame 11 at maximum, it is desirable that the opening area of the head-chip positioning hole 11b of the module frame 11 is maintained to the minimum necessary. As a result, the size of the head-chip positioning hole 11b is slightly larger than the size of the head chip 20.

Through-holes are arranged in a line to form the nozzles 25a. The through-holes face the heater elements 22 in one head chip 20, respectively. Accordingly, the number of the through-holes corresponds to the number of the heater elements 22 in one head chip 20.

To form the nozzle 25a, an excimer laser is employed. Since the nozzle 25a formed by a laser beam is tapered, the laser beam is emitted to the surface of the nozzle sheet 25 adjacent to the module frame 11 when forming the nozzle 25a. Thus, the nozzle 25a is tapered so that the diameter of the opening of the through-hole gradually decreases towards the ejection surface of ink (the outer surface of the nozzle sheet 25).

The pitch between the nozzles 25a arranged in a line and placed in the head-chip positioning hole 11b is determined to be equal to the pitch of the heater elements 22 of the head chip 20 (e.g., about 42.3 μm when the head module 10 having a resolution of 600 dpi is formed).

Furthermore, as shown in FIG. 5C, the line of the nozzles 25a in each of the head-chip positioning holes 11b (i.e., the line passing through the centers of the nozzles 25a) is formed so that the line is adjacent to the center line of the module frame 11 extending in the length direction of the module frame 11. When the head-chip positioning holes 11b are designated as “N1”, “N2”, “N3”, . . . “N8” from the left, the lines of the nozzles 25a in the head-chip positioning hole 11b designated as “N1”, “N3”, “N5”, and “N7” are positioned in a line parallel to the above-described center line of the module frame 11. Similarly, the lines of the nozzles 25a in the head-chip positioning holes 11b designated as “N2”, “N4”, “N6”, and “N8” are positioned in a line parallel to the above-described center line of the module frame 11.

Accordingly, the lines of the nozzles 25a in two neighboring head-chip positioning holes 11b, for example, the lines of the nozzles 25a in “N1” and “N2” are positioned in two lines parallel to the center line, respectively.

In this embodiment, eight head-chip positioning holes 11b are formed in one module frame 11. However, even when less than eight head-chip positioning holes 11b or more than eight head-chip positioning holes 11b are formed in the module frame 11, it is desirable that the above-described positional relationship is satisfied.

Subsequently, the head chip 20 on which the barrier layer 24 is formed is disposed and fixed in one head-chip positioning hole 11b. This operation is carried out in a second temperature environment in which a temperature lower than that in the first temperature environment is maintained (e.g., a room temperature (about 25° C.)). Under such a condition, the barrier layer 24 is bonded to the nozzle sheet 25. Here, the head chip 20 is aligned using a chip mounter and is bonded by means of thermocompression bonding. In addition, the head chip 20 is bonded so that the nozzles 25a are positioned immediately beneath the heater elements 22 of the head chip 20 while maintaining a precision of about ±1 μm.

When the head chip 20 is compared with the nozzle sheet 25, the nozzle sheet 25 has a coefficient of linear expansion higher than that of the head chip 20. Additionally, the thermocompression bonding temperature for the head chip 20 is lower than a temperature used for bonding the module frame 11 and the nozzle sheet 25. Accordingly, when the head chip 20 is subjected to thermocompression bonding, the nozzle sheet 25 in contact with the module frame 11 is stretched to a desired tension. Thus, deflection of the nozzle sheet 25 can be prevented, and therefore, the flatness of the nozzle sheet 25 can be maintained.

As noted above, when the head chip 20 having the barrier layer 24 formed thereon is disposed in the head-chip positioning hole 11b and the nozzle sheet 25 is bonded to the head chip 20, the ink chamber 26 is formed by the surface of the nozzle sheet 25 adjacent to the head chip 20, the barrier layer 24, and the surface of the head chip 20 on which the heater element 22 is formed.

Furthermore, when the head chip 20 is bonded to the nozzle sheet 25, the electrode 23 of the head chip 20 is exposed to the outside without being covered by the nozzle sheet 25 (see FIG. 4). Accordingly, after the head chip 20 is disposed in the head-chip positioning hole 11b, electrical connection with the head chip 20 is available.

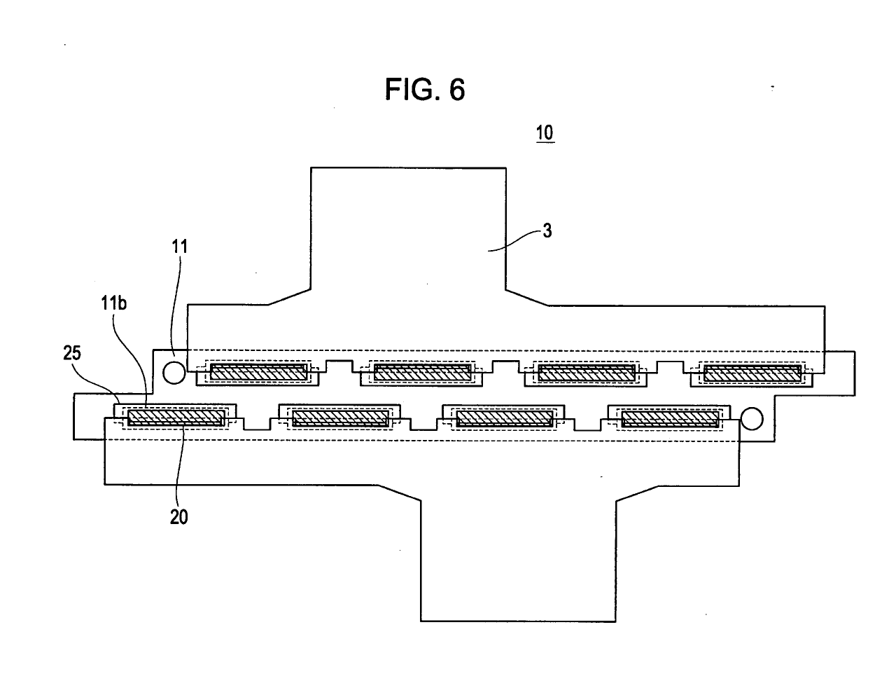

Thereafter, the electrode 23 formed on the head chip 20 is connected to the flexible wiring board 3 (electrical connection). This operation is also carried out in a third temperature environment in which a temperature lower than that in the first temperature environment is maintained (e.g., a room temperature (about 25° C.)). FIG. 6 is a plan view of the head module 10 after the nozzle sheet 25 and the head chip 20 are bonded to the module frame 11 and the flexible wiring board 3 is bonded to the head modules 10. To facilitate an understanding of this drawing, the head chips 20, which are bonded to the opposite surface, are shown by solid lines (cross-hatching).

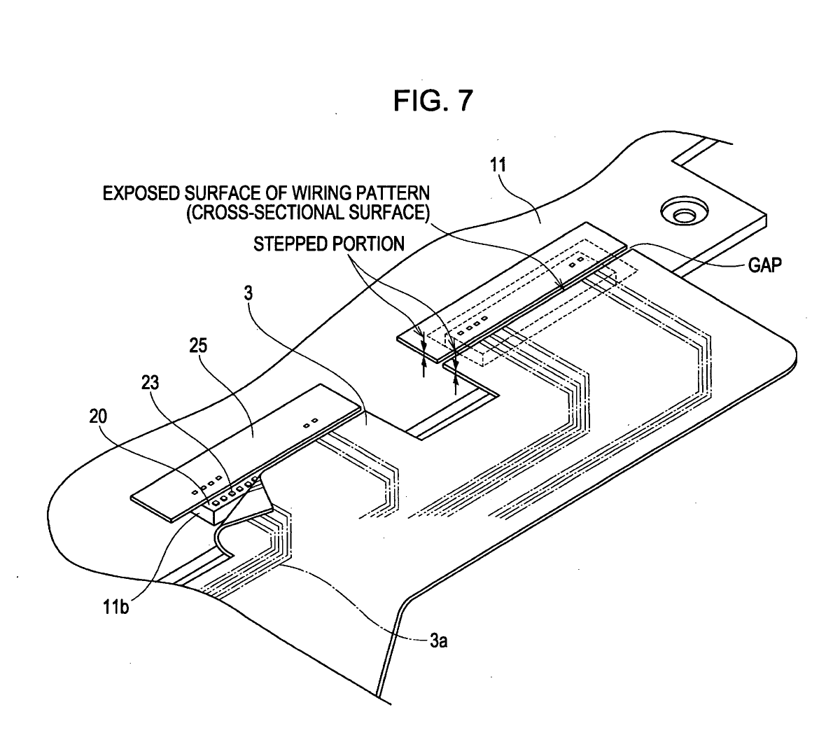

As shown in FIG. 7, the flexible wiring board 3 is produced by forming a copper-film wiring pattern 3a in a flexible film substrate (e.g., a polyimide film substrate). The flexible wiring substrate 3 has a structure in which the copper film is disposed between two film substrates made of, for example, polyimide (a structure known as a sandwich structure). Two flexible wiring boards 3 are attached to one head module 10. Four head chips 20 forms a line and two lines are arranged in parallel. The flexible wiring board 3 is attached to each line. As shown in FIG. 7, the copper-film wiring pattern 3a is formed in the flexible wiring board 3. The copper-film wiring pattern 3a is brought into contact with the electrodes 23. At that time, the flexible wiring board 3 is attached to the head module 10 so that the outer edge of the nozzle sheet 25 is in near contact with the outer edge of the flexible wiring board 3.

As shown in FIG. 4, the electrodes 23 of the head chip 20 are connected to the flexible wiring board 3 using an anisotropic conductive film 28 (an ACF connection).

After the electrodes 23 are connected to the flexible wiring board 3, a resin 29 (e.g., an epoxy resin) is provided in a gap between the head chip 20 and the module frame 11 (at the opposite side of the flow path 27) so that the anisotropic conductive film 28 is sealed. This structure prevents an electrically active portion from being short-circuited due to the intrusion of ink, since the vicinity of the head chip 20 (an upper portion in FIG. 4) is filled with ink during use of the head modules 10. In addition, a gap is formed between the outer edge of the flexible wiring board 3 and the outer edge of the nozzle sheet 25. A resin 30 is provided so as to extend from the side adjacent to the nozzle sheet 25, thus covering this gap. That is, this gap is sealed.

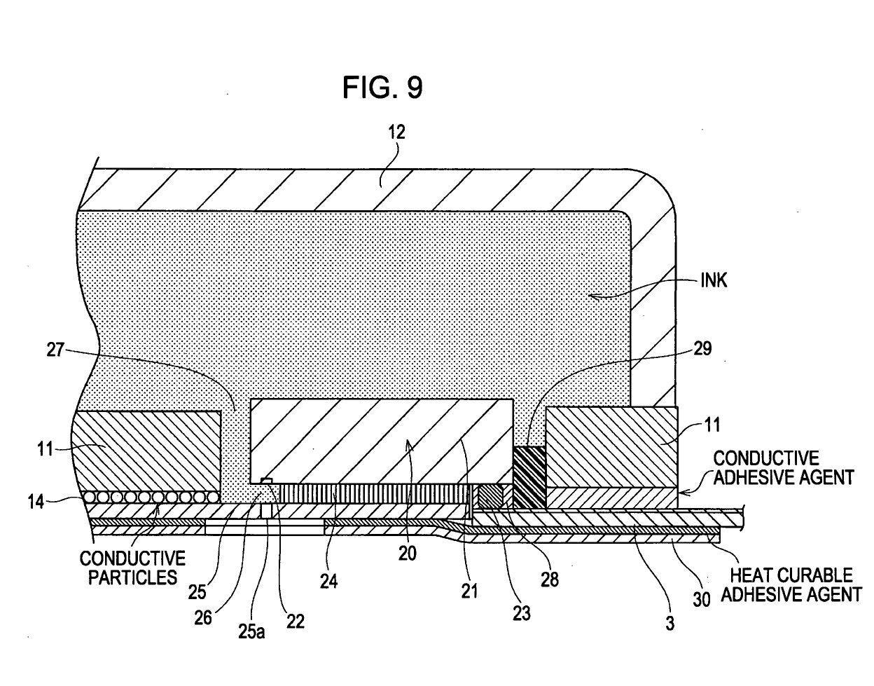

Here, as shown in FIG. 9, conductive particles may be mixed with the adhesive agent 14. In this case, a small gap is formed between the exposed surface of the wiring pattern 3a, which is the outer edge (a cross-sectional surface) of the flexible wiring board 3, and the outer edge of the nozzle sheet 25. The flexible wiring board 3 is then secured to the module frame 11 using a conductive adhesive agent (see FIG. 9).

By employing the above-described ACF connection, the wire bonding step that has been necessary in a known connection can be eliminated. In addition, a resin sealing step for securing and protecting an interconnected gold wire can be eliminated. Furthermore, the bump of the resin seal portion of wire bonding can be eliminated.

Accordingly, the ACF connection can reduce the manufacturing cost and can provide a nozzle surface without a bump of a sealing resin. However, precisely speaking, as shown in FIG. 7, the nozzle surface formed by bonding the nozzle sheet 25 and the flexible wiring board 3 to a surface of the module frame 11 has a stepped portion having a height of ten and several μm, which is the thickness of the nozzle sheet 25 or the flexible wiring board 3, at the ends of the nozzle sheet 25 and the flexible wiring board 3. Although this stepped portion is not level with the resin seal portion of wire bonding, ridge lines of the ends form edges, and therefore, a roller or a blade can be easily caught by the stepped portion when moving over the stepped portion during cleaning of the surface. Consequently, the nozzle sheet 25 or the flexible wiring board 3 caught by the roller or blade could be peeled away from the module frame 11. In addition, the roller or blade could be damaged when moving over the stepped portion.

In general, when the head is not operated, the nozzle surface is covered by a head cap (not shown). The head cap protects the nozzle surface from being damaged and prevents ink from drying. Some head caps include an ink absorbing mechanism to absorb ink in order to prevent the ink from clogging the nozzles 25a. To maximize the advantage of these features, the head cap is formed from a resilient material, such as a rubber. The head cap is designed so that the airtightness is maintained when the head cap covers the nozzle surface. However, if the head cap is disposed over the stepped portion on the nozzle surface, the airtightness may be lost.

Furthermore, in the structure in which the flexible wiring board 3 is bonded and secured to the module frame 11, a side surface of the wiring pattern 3a to be connected to the electrode 23 of the head chip 20 is exposed to the outside due to the presence of a gap between the side surface of the wiring pattern 3a and the nozzle sheet 25. If conductive ink or dust is deposited to the side surface, a short circuit may occur.

Still furthermore, when the nozzle surface is formed by bonding different materials (such as a stainless steel for the module frame 11, nickel for the nozzle sheet 25, and polyimide for the flexible wiring board 3), the surface state of the nozzle surface varies depending on the positions, since the wettability differs depending on the materials. In addition, if the difference between the levels of wettability is large, the amounts of ink deposited to the nozzle surface differ depending on the position. Thus, a puddle of the ink could be generated in the vicinity of the nozzle 25a. If the puddle of the ink is present in the vicinity of the nozzle 25a, the ejecting direction of the ink becomes unstable. Thus, the quality of recording (an image) may significantly deteriorate. For example, a printed character may be deformed or a printed image may have some defects. In addition, since the distribution of the amount of ink deposited on the nozzle surface is not uniform, the distribution of contamination on the nozzle surface is not uniform. Thus, the cleaning performance may become unstable.

As described above, the ends of the nozzle sheet 25 and the flexible wiring board 3 (the stepped portion of the nozzle surface) interfere with the cleaning operation and capping operation. Additionally, the gap adjacent to the exposed surface (cross-sectional surface) of the wiring pattern 3a may cause a short circuit. Furthermore, if the nozzle surface is formed from different materials, the wettability is not uniform. Thus, the ink ejection performance and cleaning performance may be degraded.

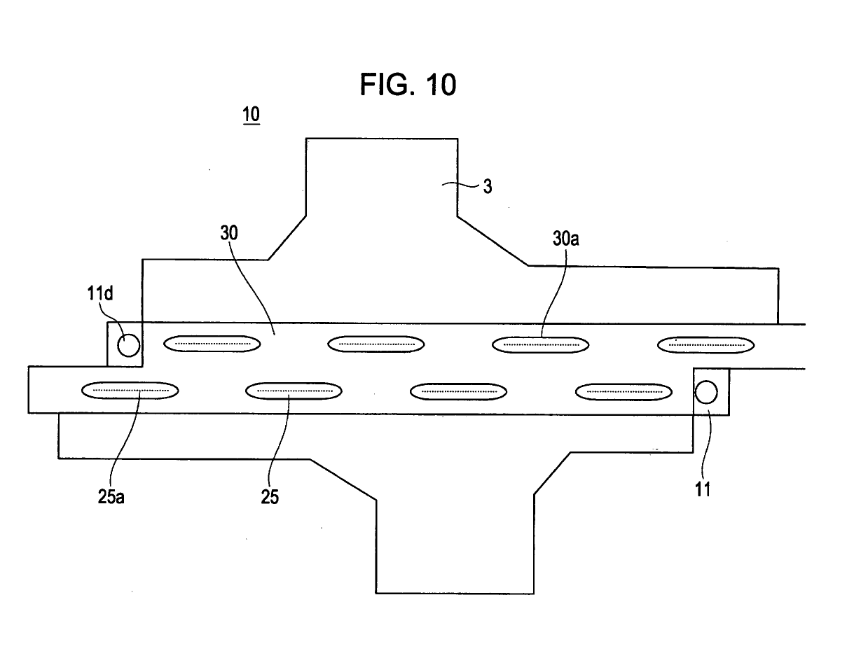

To solve such problems relating to the structure of the nozzle surface, a protective cover 30 may be bonded to the nozzle surface. FIG. 10 is a plan view of the module frame 11, the nozzle sheet 25, and the flexible wiring board 3 on which the protective cover 30 is bonded. As shown in FIG. 10, the protective cover 30 covers the nozzle sheet 25 excluding the nozzles 25a and the vicinity of the nozzles 25a, which is a area defined by a window portion 30a, the module frame 11 excluding the mounting holes lid and the vicinity of the mounting holes 11d, and part of the flexible wiring board 3 that overlaps the module frame 11. In this embodiment, the protective cover 30 is formed as follows: a heat-curable adhesive agent is applied to (printed on) a bonding surface of a highly heat-resistant, highly insulating, and flexible polyimide film (see FIG. 9); this polyimide film is bonded to the nozzle surface; and, by applying heat, the polyimide film is heat-cured and secured to the nozzle surface. The window portion 30a has a size so that dirt on the nozzle surface can be removed during a cleaning operation and has a substantially oval shape so that the roller or a blade can easily move over the window portion 30a.

The protective cover (the adhered polyimide film) 30 covers and protects the ends of the nozzle sheet 25 and the flexible wiring board 3 so as to cover the edges of the nozzle sheet 25 and the flexible wiring board 3. Thus, the height of the stepped portion of the nozzle surface is reduced. Furthermore, the gap between the outer edge of the flexible wiring board 3 and the outer edge of the nozzle sheet 25 is covered. Accordingly, when the roller or blade moves over the stepped portion for cleaning the nozzle surface, the possibility that the nozzle sheet 25 or the flexible wiring board 3 is peeled away and the roller or blade is damaged is reduced. In addition, the occurrence of a short circuit on the exposed surface (cross-sectional surface) of the wiring pattern 3a of the flexible wiring board 3 can be eliminated. Furthermore, since the stepped portion is changed to a gentle slope portion, the head cap (not shown) having an ordinary resilience can follow the shape of the portion. Thus, the airtightness of the head cap can be ensured. Furthermore, since the surfaces of the module frame 11, the nozzle sheet 25, and the flexible wiring board 3 (excluding the vicinity of the nozzles 25a) can be formed from the same material (the polyimide resin), the wettability of the nozzle surface can be substantially uniform regardless of the position. Thus, the quality of recording can be increased and the cleaning performance can be stable.

It is noted that the ink includes an ionic material serving as a conductive agent to facilitate the detection of the remaining amount of ink. Accordingly, as shown in FIG. 9, the gap between the head chip 20 and the module frame 11 (on the opposite side of the flow path 27) is sealed by the resin 29 (e.g., an epoxy resin) to prevent the ink from causing a short circuit of the electrically active portion.

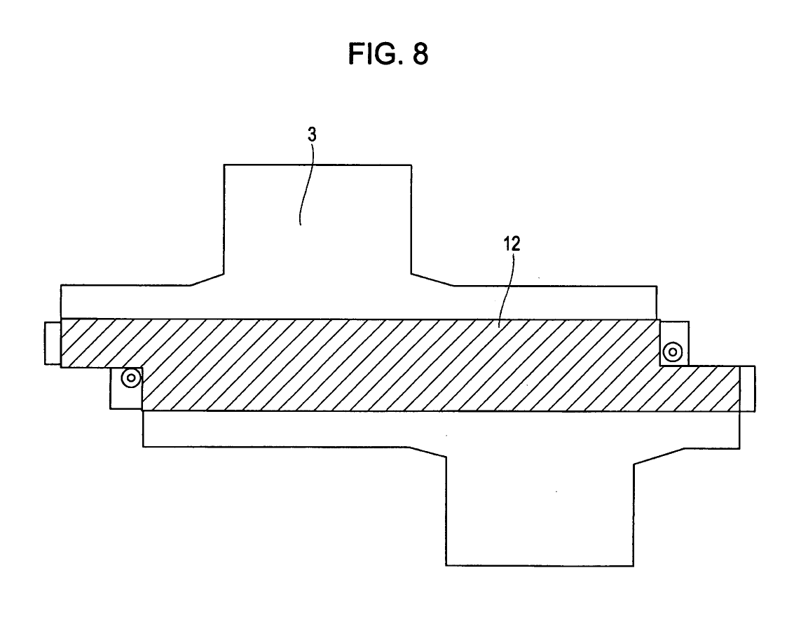

Subsequently, as shown in FIGS. 4 and 8, the buffer tank 12 is bonded so as to cover the upper portion of the head chip 20. FIG. 8 is a plan view illustrating the buffer tank 12 and the flexible wiring board 3.

The buffer tank 12 is a tank for temporarily storing ink. One buffer tank 12 is provided to one head module 10.

As shown in FIG. 8, the buffer tank 12 has substantially the same shape as that of the module frame 11 in plan view. As shown in FIG. 4, inside the buffer tank 12, a hollow liquid flow path (shown by halftone dots in FIG. 4) is formed. In particular, according to this embodiment, the buffer tank 12 is open at the bottom (on the side adjacent to the bonding surface of the module frame 11). The side walls and the top wall of the buffer tank 12 have the same thickness. The cross-sectional shape of the buffer tank 12 is a substantially inverted U shape.

The buffer tank 12 forms a liquid flow channel that is common to all the head chips 20. The buffer tank 12 temporarily stores ink to be supplied to the ink chamber 26. In particular, according to this embodiment, the buffer tank 12 also serves as a rigid supporting member used for securing the module frame 11.

After the buffer tank 12 is attached to the module frame 11, the buffer tank 12 covers all the head-chip positioning holes 11b, as shown in FIG. 8. Also, as shown in FIG. 4, the interior of the buffer tank 12 communicates with the ink chamber 26 of each head chip 20 via the flow path 27 between the head-chip positioning hole 11b and the head chip 20. Thus, the buffer tank 12 forms a liquid flow channel that is common to all the head chips 20 of the head modules 10.

A hole (not shown) is formed in the top wall of the buffer tank 12. Ink is supplied from an ink tank (not shown) to the interior of the buffer tank 12 via this hole.

The module frame 11, each of the head chip 20, and the buffer tank 12 have the same coefficient of linear expansion. This is because, if the difference between the coefficients of linear expansion is large, the adhesive agent may peel off due to thermal stress. This design prevents such a problem.

Additionally, according to the present embodiment, the liquid ejection head 1 includes a plurality of the head modules 10.

As shown in FIG. 1, the head module positioning hole 2a is formed in the rigid head frame 2. According to the present embodiment, in the head module positioning hole 2a, eight head modules 10 are disposed (two head modules 10 are connected in series and four pairs of the series-connected head modules 10 are disposed in four tiers). Each of the head modules 10 is fixed by screws so that the position of each head module 10 is fixed.

In FIG. 2, the buffer tanks 12 of the eight head modules 10 are shown. The buffer tanks 12 are connected in series using U-shaped pipes 13. Two connecting ends of the flexible wiring board 3 (cross-hatching portions in FIG. 2) extend perpendicularly to the plane of FIG. 2 for each head module 10.

As shown in FIG. 3, using screws 5, a control board 4 for controlling the ejection of liquid is secured to the surface of the head frame 2 having the buffer tank 12 mounted thereon. On the control board 4, a variety of capacitors and connectors 4a for the connection with the flexible wiring boards 3 are provided. In the vicinity of the connectors 4a, cutout portions 4b are formed. The top ends of the flexible wiring boards 3 extend upwardly through the cutout portions 4b from the lower surface to the upper surface of the control board 4. The top ends are connected to the connectors 4a of the control board 4.

Thus, two head modules 10 are connected in series to form a line head for A4 paper size. Furthermore, four lines of head modules 10 (each line including the two series-connected head modules 10) are arranged to form a color line head for four colors (i.e., Y, M, C, and K).

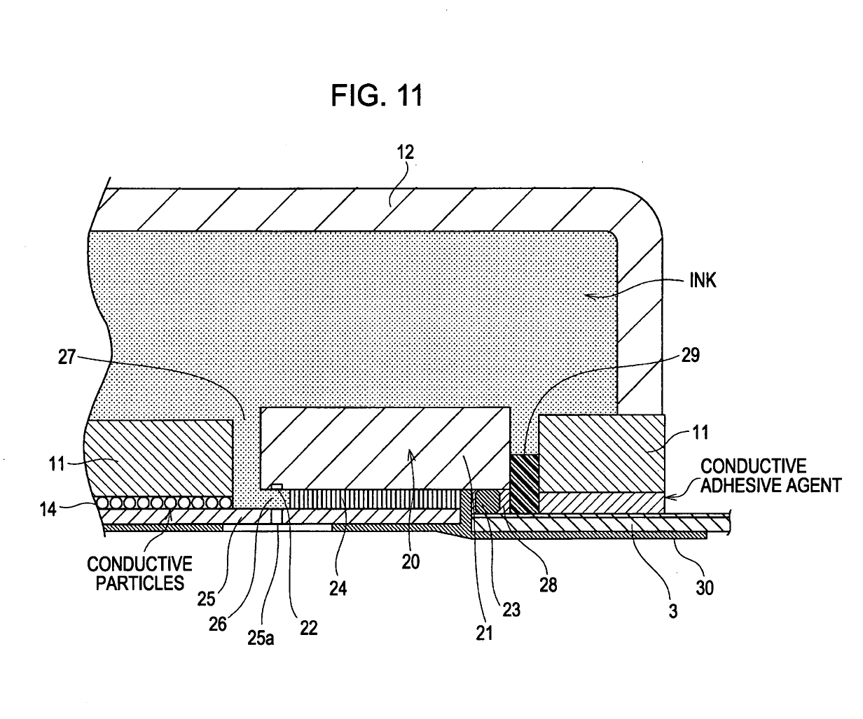

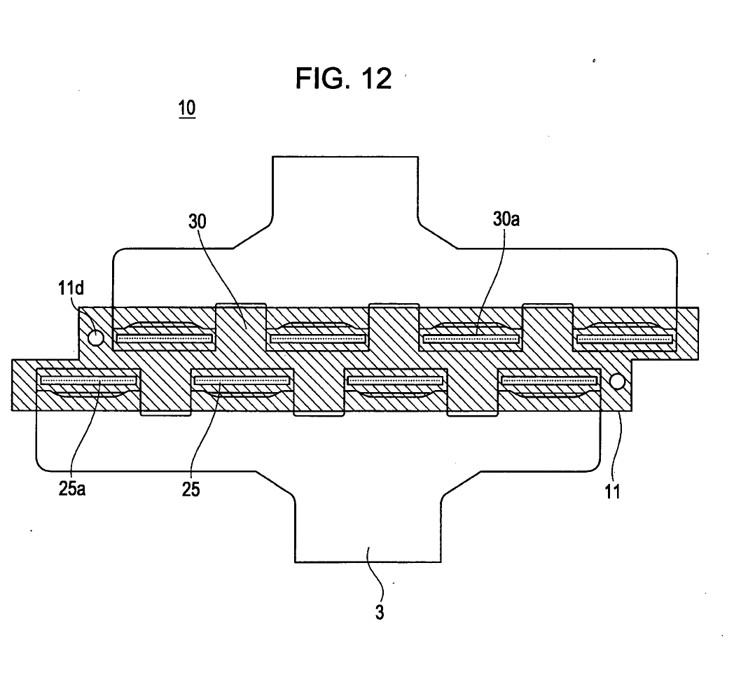

FIG. 11 is a cross-sectional view of a head chip 20 and the vicinity thereof in a liquid ejection head 1 according to another embodiment of the present invention. FIG. 12 is a plan view of a module frame 11, a nozzle sheet 25, and a flexible wiring board 3 covered by a protective cover 30.

In the embodiment shown in FIGS. 11 and 12, the protective cover 30 is a resin layer that covers the nozzle sheet 25 excluding the nozzle sheet 25 and the vicinity thereof, the exposed portion of the module frame 11, a portion of the flexible wiring board 3 that overlaps the module frame 11.

The protective cover 30 is formed from a heat-curable epoxy resin having excellent characteristics (such as adhesiveness, toughness, heat resistance, electrical insulation properties, and corrosion resistance). This resin is applied to the entire nozzle surface except for the nozzles 25a and the vicinity thereof using screen printing (silk printing) (see a cross-hatching portion of FIG. 12). The screen printing provides a precise application of the epoxy resin so that the vicinity of the nozzle 25a exactly corresponds to the window portion 30a. The applied epoxy resin is cured by applying heat. The cured epoxy resin makes the protective cover 30.

The protective cover (the cured epoxy resin film) 30 covers and protects the ends of the nozzle sheet 25 and the flexible wiring board 3 so as to cover the edges of the nozzle sheet 25 and the flexible wiring board 3. Thus, the height of the stepped portion of the nozzle surface is reduced. In addition, the gap between the outer edge of the flexible wiring board 3 and the outer edge of the nozzle sheet 25 is covered. Accordingly, when the roller or blade moves over the stepped portion for cleaning the nozzle surface, the possibility that the nozzle sheet 25 or the flexible wiring board 3 is peeled away and the roller or blade is damaged is reduced. In addition, the occurrence of a short circuit on the exposed surface (cross-sectional surface) of the wiring pattern 3a of the flexible wiring board 3 can be eliminated. Furthermore, since the stepped portion is changed to a gentle slope portion, a head cap (not shown) having an ordinary resilience can follow the shape of the portion. Thus, the airtightness of the head cap can be ensured. Furthermore, since the surfaces of the module frame 11, the nozzle sheet 25, and the flexible wiring board 3 (excluding the vicinity of the nozzles 25a) can be formed from the same material (the epoxy resin), the wettability of the nozzle surface can be substantially uniform regardless of the position. Thus, the quality of recording can be increased and the cleaning performance can be stable.

As well as a polyimide resin or epoxy resin, a resin having excellent heat resistance and ink resistance characteristics (e.g., a silicon resin or acrylic resin) can be used as a resin for forming the protective cover 30. In addition to a heat-curable resin, a UV-curable resin can be used.

As described above, according to the present embodiment, the material of the nozzle sheet 25 can be used for only required portions. Accordingly, the cost of the nozzle sheet 25 for the material for one liquid ejection head 1 and one head modules 10 can be reduced to a minimum. The cost of the nozzle sheet 25 produced by means of electroforming is substantially proportional to the area of the nozzle sheet 25. According to the present embodiment, the area of the nozzle sheet 25 is reduced to about 20% of the area required in Japanese Patent No. 3608526. Thus, the cost can be reduced by 80%.

In addition, the reduction in the size of the nozzle sheet 25 can reduce the number of defects occurring in the manufacturing steps (such as deformation or a tear).

Furthermore, by using a plurality of the head modules 10 in place of the liquid ejection head used in Japanese Patent No. 3608526, when one of the head modules 10 becomes defective (e.g., only one head chip 20 does not function), only the defective head module 10 can be replaced with a new one. It is not necessary that the whole liquid ejection head 1 is replaced.

According to the present embodiment, when the head chip 20 is electrically connected to the flexible wiring board 3, the wire bonding step and the resin sealing step can be eliminated. Thus, the manufacturing cost can be reduced. In addition, by covering the nozzle surface with the protective cover 30, the ends of the nozzle sheet 25 and the flexible wiring board 3 joined to the nozzle surface can be protected. Also, the height of the stepped portion of the ends can be reduced. Therefore, a damage of a cleaning member (such as a roller or blade) can be eliminated. Also, the sealability of the head cap can be increased, and therefore, the high performance of the head can be maintained.

Still furthermore, since the exposed ends of the wiring pattern 3a of the flexible wiring board 3 is protected, the occurrence of a short circuit can be prevented. In addition, since the protective cover 30 provides substantially uniform wettability of the nozzle surface, the direction of ejecting an ink droplet can be stable, and therefore, the deformation of a printed character or a damage of an image can be reduced. Also, since the distribution of the amount of ink deposited on the nozzle surface becomes uniform, the cleaning performance becomes stable.

It should be understood by those skilled in the art that various modifications, combinations, sub-combinations and alterations may occur depending on design requirements and other factors insofar as they are within the scope of the appended claims or the equivalents thereof.

What is claimed is:

1. A head module comprising:
a head chip including a plurality of energy-generating elements, a barrier layer, and an electrode for external electrical connection provided on a semiconductor substrate, the energy-generating elements being arranged substantially in a line with a predetermined spacing therebetween, the barrier layer forming a liquid chamber around the energy-generating elements;
a nozzle sheet having nozzles formed therein;
a wiring board electrically connected to the electrode of the head chip; and
a module frame having a plurality of head chip positioning holes formed therein, the size of each head chip positioning hole being slightly larger than the head chip, the head chip being disposed in one of the head chip positioning holes;
wherein liquid in the liquid chamber is ejected from the nozzles by means of an ejecting force provided to the liquid by the energy-generating elements, and wherein the nozzle sheet is disposed on a first surface of the module frame so that the nozzles are located in the head chip positioning hole and the nozzle sheet partially covers the head chip positioning hole and the size of the nozzle sheet is determined to be a minimum size required for partially covering the head chip positioning hole, and wherein the head chip is disposed on a second surface of the module frame so that the head chip is located in the head chip positioning hole and the energy-generating elements face their corresponding nozzles, and wherein the electrode of the head chip disposed in the head chip positioning hole is exposed through an area of the head chip positioning hole not covered by the nozzle sheet, and wherein an electrode of the wiring board is electrically connected to the electrode of the head chip and the wiring board is disposed on the first surface of the module frame so as to cover the exposed electrode of the head chip.

2. The head module according to claim 1, wherein a plurality of the head chips are arranged in series to form a head chip line and a plurality of the head chip lines are arranged in parallel.

3. The head module according to claim 2, wherein each of the head chip lines is provided with the wiring board.

4. The head module according to claim 1, further comprising:
a tank disposed on the second surface of the module frame so as to cover all of the head chip positioning holes, the tank communicating with all of the liquid chambers of the head chips.

5. A liquid ejection head comprising:
a plurality of head modules, each including a head chip, a nozzle sheet having nozzles formed therein, a wiring board, and a module frame, the head chip including a plurality of energy-generating elements, a barrier layer, and an electrode for external electrical connection provided on a semiconductor substrate, the energy-generating elements being arranged substantially in a line with a predetermined spacing therebetween, the barrier layer forming a liquid chamber around the energy-generating elements, the wiring board being electrically connected to the electrode of the head chip, the module frame having a plurality of head chip positioning holes formed therein, the head chip being disposed in one of the head chip positioning holes; and
a head frame having a head module positioning hole for containing the plurality of head modules;
wherein liquid in the liquid chamber is ejected from the nozzles by means of an ejecting force provided to the liquid by the energy-generating elements, and wherein the nozzle sheet is disposed on a first surface of the module frame so that the nozzles are located in the head chip positioning hole and the nozzle sheet partially covers the head chip positioning hole and the size of the nozzle sheet is determined to be a minimum size required for partially covering the head chip positioning hole, and wherein the head chip is disposed on a second surface of the module frame so that the head chip is located in the head chip positioning hole and the energy-generating elements face their corresponding nozzles, and wherein the electrode of the head chip disposed in the head chip positioning hole is exposed through an area of the head chip positioning hole not covered by the nozzle sheet, and wherein an electrode of the wiring board is electrically connected to the electrode of the head chip and the wiring board is disposed on the first surface of the module frame so as to cover the exposed electrode of the head chip.

6. A liquid ejection apparatus comprising:
a plurality of head modules, each including a head chip, a nozzle sheet having nozzles formed therein, a wiring board, and a module frame, the head chip including a plurality of energy-generating elements, a barrier layer, and an electrode for external electrical connection provided on a semiconductor substrate, the energy-generating elements being arranged substantially in a line with a predetermined spacing therebetween, the barrier layer forming a liquid chamber around the energy-generating elements, the wiring board being electrically connected to the electrode of the head chip, the module frame having a plurality of head chip positioning holes formed therein, the head chip being disposed in one of the head chip positioning holes; and
a head frame having a head module positioning hole for containing the plurality of head modules;
wherein liquid in the liquid chamber is ejected from the nozzles by means of an ejecting force provided to the liquid by the energy-generating elements, and wherein the nozzle sheet is disposed on a first surface of the module frame so that the nozzles are located in the head chip positioning hole and the nozzle sheet partially covers the head chip positioning hole and the size of the nozzle sheet is determined to be a minimum size required for partially covering the head chip positioning hole, and wherein the head chip is disposed on a second surface of the module frame so that the head chip is located in the head chip positioning hole and the energy-generating elements face their corresponding nozzles, and wherein the electrode of the head chip disposed in the head chip positioning hole is exposed through an area of the head chip positioning hole not covered by the nozzle sheet, and wherein an electrode of the wiring board is electrically connected to the electrode of the head chip and the wiring board is disposed on the first surface of the module frame so as to cover the exposed electrode of the head chip.

7. A method of manufacturing a head module, the head module including a head chip including a plurality of energy-generating elements, a barrier layer, and an electrode for external electrical connection provided on a semiconductor substrate, the energy-generating elements being arranged substantially in a line with a predetermined spacing therebetween, the barrier layer forming a liquid chamber around the energy-generating elements, a nozzle sheet having nozzles formed therein, a wiring board electrically connected to the electrode of the head chip, and a module frame having a plurality of head chip positioning holes formed therein, the head chip being disposed in one of the head chip positioning holes, wherein liquid in the liquid chamber is ejected from the nozzles by means of an ejecting force provided to the liquid by the energy-generating elements, the method comprising the steps of:
(a) bonding, in a first temperature environment, the nozzle sheet to a first surface of the module frame so that the nozzles are located in the head chip positioning hole and the nozzle sheet partially covers the head chip positioning hole;
(b) bonding, in a second temperature environment in which a temperature is lower than a temperature in the first environment, the head chip to a second surface of the module frame so that the head chip is located in the head chip positioning hole and the energy-generating elements face their corresponding nozzles; and
(c) mounting the wiring board on the first surface of the module frame so that an electrode of the wiring board is electrically connected to the electrode of the head chip.

8. A method of manufacturing a head module, the head module including a head chip including a plurality of energy-generating elements, a barrier layer, and an electrode for external electrical connection provided on a semiconductor substrate, the energy-generating elements being arranged substantially in a line with a predetermined spacing therebetween, the barrier layer forming a liquid chamber around the energy-generating elements, a nozzle sheet having nozzles formed therein, a wiring board electrically connected to the electrode of the head chip, and a module frame having a plurality of head chip positioning holes formed therein, the head chip being disposed in one of the head chip positioning holes, wherein liquid in the liquid chamber is ejected from the nozzles by means of an ejecting force provided to the liquid by the energy-generating elements, the method comprising the steps of:
(a) bonding, in a first temperature environment, the nozzle sheet to a first surface of the module frame so that the nozzles are located in the head chip positioning hole and the nozzle sheet partially covers the head chip positioning hole;
(b) bonding, in a second temperature environment in which a temperature is lower than a temperature in the first environment, the head chip to a second surface of the module frame so that the head chip is located in the head chip positioning hole and the energy-generating elements face their corresponding nozzles;
(c) mounting the wiring board on the first surface of the module frame so that an electrode of the wiring board is electrically connected to the electrode of the head chip; and
(d) coating ends of the nozzle sheet and the wiring board bonded to the module frame.

9. The method of manufacturing a head module according to claim 8, wherein step (d) includes bonding a resin film to the nozzle sheet excluding the nozzles and the vicinity of the nozzles thereof, the first surface of the module frame, and part of the wiring board that overlaps the module frame by applying an adhesive agent to a surface of the resin film.

10. The method of manufacturing a head module according to claim 8, wherein step (d) includes applying a resin material to the nozzle sheet excluding the nozzles and the vicinity of the nozzles, the first surface of the module frame, and part of the wiring board that overlaps the module frame.

11. The method of manufacturing a head module according to claim 8, further comprising the step of:
(e) mounting a tank on the second surface so as to cover all of the head chip positioning holes, the tank communicating with the liquid chambers of all of the head chips.

12. A method of manufacturing a liquid ejection head, the liquid ejection head including a plurality of head modules and a head frame having a head module positioning hole for containing the plurality of head modules, each of the head modules including a head chip, a nozzle sheet having nozzles formed therein, a wiring board, a module frame, and a tank, the head chip including a plurality of energy-generating elements, a barrier layer, and an electrode for external electrical connection provided on a semiconductor substrate, the energy-generating elements being arranged substantially in a line with a predetermined spacing therebetween, the barrier layer forming a liquid chamber around the energy-generating elements, the wiring board being electrically connected to the electrode of the head chip, the module frame having a plurality of head chip positioning holes formed therein, the head chip being disposed in one of the head chip positioning holes, the tank being disposed so as to cover all of the head chip positioning holes, the tank communicating with the liquid chambers of all of the head chips, wherein liquid in the liquid chambers is ejected from the nozzles by means of an ejecting force provided to the liquid by the energy-generating elements, the method comprising the steps of:
(a) bonding, in a first temperature environment, the nozzle sheet to a first surface of the module frame so that the nozzles are located in the head chip positioning hole and the nozzle sheet partially covers the head chip positioning hole;
(b) bonding, in a second temperature environment in which a temperature is lower than a temperature in the first environment, the head chip to a second surface of the module frame so that the head chip is located in the head chip positioning hole and the energy-generating elements face their corresponding nozzles;
(c) mounting the wiring board on the first surface of the module frame so that an electrode of the wiring board is electrically connected to the electrode of the head chip;
(d) coating ends of the nozzle sheet and the wiring board bonded to the module frame;
(e) mounting the tank on the second surface of the module frame so as to form the head module; and
(f) disposing the plurality of head modules in the head module positioning hole of the head frame.

13. A method of manufacturing a liquid ejection apparatus, the liquid ejection apparatus including a plurality of head modules and a head frame having a head module positioning hole for containing the plurality of head modules, each of the head modules including a head chip, a nozzle sheet having nozzles formed therein, a wiring board, a module frame, and a tank, the head chip including a plurality of energy-generating elements, a barrier layer, and an electrode for external electrical connection provided on a semiconductor substrate, the energy-generating elements being arranged substantially in a line with a predetermined spacing therebetween, the barrier layer forming a liquid chamber around the energy-generating elements, the wiring board being electrically connected to the electrode of the head chip, the module frame having a plurality of head chip positioning holes formed therein, the head chip being disposed in one of the head chip positioning holes, the tank being disposed so as to cover all of the head chip positioning holes, the tank communicating with the liquid chambers of all of the head chips, wherein liquid in the liquid chambers is ejected from the nozzles by means of an ejecting force provided to the liquid by the energy-generating elements, the method comprising the steps of:
(a) bonding, in a first temperature environment, the nozzle sheet to a first surface of the module frame so that the nozzles are located in the head chip positioning hole and the nozzle sheet partially covers the head chip positioning hole;
(b) bonding, in a second temperature environment in which a temperature is lower than a temperature in the first environment, the head chip to a second surface of the module frame so that the head chip is located in the head chip positioning hole and the energy-generating elements face their corresponding nozzles;
(c) mounting the wiring board on the first surface of the module frame so that an electrode of the wiring board is electrically connected to the electrode of the head chip;
(d) coating ends of the nozzle sheet and the wiring board bonded to the module frame;
(e) mounting the tank on the second surface of the module frame so as to form the head module; and
(f) disposing the plurality of head modules in the head module positioning hole of the head frame.
